(19) United States
(12) Patent Application Publication
(10) Pub. No.: US 2022/0006791 A1
(43) Pub. Date: Jan. 6, 2022

(54) Secured Node Authentication and Access Control Model for IoT Smart City

(71) Applicant: Mohammed Mujib Alshahrani, Bisha (SA)

(72) Inventor: Mohammed Mujib Alshahrani, Bisha (SA)

(21) Appl. No.: 17/376,296

(22) Filed: Jul. 15, 2021

(51) Int. Cl. H04L 29/06

(52) U.S. Cl. CPC H04L 63/0428; H04L 63/105

(57) ABSTRACT

Our Invention a Secured Node Authentication and Access Control Model for IoT Smart City using Double Hashed Unique Labelled Key based Validation is a IoT builds a global network of linked objects or items that will play an active part in the Future Internet (FI). It is assumed that 50 billion devices will be connected to the internet by 2020, and there will be multiple applications and services. In order to create safety solutions, the heterogeneous nature of IoT communications and with the imbalance in resources between IoT devices, IoT presents new challenges to security and privacy, which render the provision of the necessary protected connections end-to-end. Most IoT devices have limited power, energy and memory capacities, and have therefore limited the possible security solutions choices because many of the security mechanisms developed cannot be supported by low-capacity devices. IoT needs comprehensive security solutions that meet the relevant safety and privacy criteria effectively and that have a small effect on system resources.

### TECHNICAL FIELD

The present disclosure relates to a Secured Node Authentication and Access Control Model for an information-of-things (IoT) Smart City using Double Hashed Unique Labelled Key based Validation.

### BACKGROUND

IoT builds a global network of linked objects or items that will play an active part in the Future Internet (FI). It is assumed that 50 billion devices will be connected to the internet by 2020, and there will be multiple applications and services. In order to create safety solutions, the heterogeneous nature of IoT communications and with the imbalance in resources between IoT devices, IoT presents new challenges to security and privacy, which render the provision of the necessary protected connections end-to-end.

Most IoT devices have limited power, energy, and memory capacities, and have, therefore, limited the possible security solutions choices because many of the security mechanisms developed cannot be supported by low-capacity devices. IoT needs comprehensive security solutions that meet the relevant safety and privacy criteria effectively and that have a small effect on system resources.

### Database

The Ubiquitous IoT Computing Concept makes it possible for IoT physical devices communicate seamlessly with Internet infrastructure via different wireless communication technologies. IoT allows the idea of anywhere contact that creates an enormous amount of data produced by IoT devices, and a wide range of applications that challenges IoT confidentiality.

Thousands of heterogeneous devices in open-ended and complex spaces would certainly increase the risk of privacy. Sensitive and private information is shared in applications such as smart cities or smart healthcare that exploits attackers to use such information to breach privacy. In addition, information related to the position of certain sensitive network nodes like the source node and sink node location, which can be used by eavesdroppers to develop further attacks aimed at these nodes or events.

IoT devices are usually lightweight, low cost, and resource constrained. The challenges and problems of IoT are growing. In IoT applications such as intelligent buildings, security and privacy problems in smart cities are among the major issues. Remote cybersecurity attacks are attacks that do not include physical IoT network access, in which an attacker can access and communicate with IoT devices remotely via a wireless channel. Remote attacks on cyber security are also a major challenge. Emerging technologies in intelligent environments like smart buildings require both user and resource remote access.

As the user/constructor communication channel is vulnerable the authentication protocol must be light and stable. In the proposed model, a secure user authentication protocol for smart city with restricted access control is proposed. The protocol makes it possible to anonymously, unlike and untraceably authenticate only legitimate users using smart controllers.

The wide range of IoT applications reveals that emerging technologies have personal, social, and cultural consequences. IoT is also used to improve the productivity of households and employment. The sensors can interact and function, such as ordering food in the refrigerator when the refrigerator is empty. They can alert Smartphone when the washing machine is finished. However, the consequences of these device failures may be too expensive because it relies heavily on IoT. The failure will generate incorrect data and lead to dangerous results if this information is used in automated households or production for decision-making purposes.

IoT has been proposed for a variety of authentication systems, it is aware that none of the contributions considered the authentication and access control anonymous of IoT sensor nodes. The proposed protocol allows shared authentication and anonymity and the ability to unlink information transmitted. In addition, the possibility of insider threats was mitigated by establishing the virtual domain segregation within IoT standalone networks, limiting the ability of IoT nodes, and implementing a cumulative double hashed unique labelled key validation model for user authentication and restricting access control.

The mam feature of IoT nodes is that the approved user can collect environmental information and can gain access on the network. These sensor nodes are accurate, mobile, affordable, and easy to fit. These innovations serve the automotive, health, logistics, environmental monitoring, and many other building blocks. In a centralized approach, the application platform collects information from network entities and supports other entities.

Smart City automation transforms ordinary city communication appliances into intelligent and smart devices that enable system remote control and administration through the internet. In smart city appliances such as smart traffic, weather management, water management, Garbage management etc. can be operated remotely, thereby simplifying and comfortably making life easier. Security violations could be dangerous, imagine a robber hacks the door lock system and successfully open the door or the perpetrator monitor the lighting system to make your life miserable.

These systems continue to record conduct and actions that could pose a direct threat to personal privacy. In order to minimize the risk of such attacks, however, protection and privacy should be maintained by strong authentication and access control mechanisms.

In this proposed work, an IoT environment Access Control Management Model is introduced including automatic settings to reduce the burden of users. The proposed model is necessary when IoT devices first bind to the access control server, exchanging application and authentication information for authentication information to the device. The access destination often requests the management system to authorize the access source. Control source can therefore access like an IoT system without taking the scope of access into account. Without the preconfiguring and reconfiguring of IoT devices, the proposed approach enables effective and unified access management for IoT setting.

Access control in the TOT environment is necessary to ensure that software updates, access sensor data and the sensors cannot be controlled by trusted users alone. Access control addresses problems in data ownership and allows new services, including Sensors as a Service, where customer information is supplied by sensors. Access controls enable IoT device data to be shared with approved users so that sensitive data can be predictively maintained as well as protected. The development of the Internet has led to new types of services with particular reference to the use of sensors and actuators. The Internet of Things is known for these services. A secure and simple access control system for the data handled in these facilities is a major challenge currently.

By modelling IoT communication elements as tools, the incorporation of IoT devices into an access control framework is proposed. This would enable us to achieve a unified system of access control between heterogeneous devices. To that end, we examined the most important communication protocols for such environments and then proposed a methodology that enables communication behavior to be modeled as tools. Then, through access control mechanisms, we can secure these services.

The key elements in dealing with protection and privacy problems on the Internet of Things are authentication and access control technologies. Every successful access control system should actually meet the core security characteristics of confidentiality, trust, and availability. Information on models, policies and mechanisms for access control are available. The following functions are covered by a comprehensive access control system. They are authentication and accountability.

Smart environment uses rich combinations of small computer nodes to define and provide users with customized services when interacting and exchanging information with the environment. In order to offer intelligence and enhance the quality of life, IoT is used to build smart cities. “Internet of things technology” can be described as a “smart city” which is automated and can respond to people's needs to offer them comfort, security, and entertainment. The IoT is expected to develop in the future important applications for smart state and industry, enhancing the quality of life and the world economy.

With IoT, electrical and electronic devices mounted in smart city can be accessed and controlled from anywhere in the world remotely. Intelligent cities allow their people to open their garage automatically when they enter into city, trigger the municipal staff when garbage is full, order for water tank when water is in minimum range, get weather reports and other traffic updated. The Smart Cities are composed of smart devices and automation systems. It's all related to Internet assistance launched a light-weight and stable IoT smart city session key set-up scheme.

They have taken advantage of a short token to create a session key between and an intelligent computer. The stable key agreement for smart systems. The proposed arrangement is appropriate for smart city consumer electronics products. Proposed a small, essential setup protocol and a session key between nodes and control was created. There is no reciprocal authentication among users in their scheme implemented a smart home remote user authentication system that uses Elliptical Curve Cryptography (ECC). Two main safety features called anonymity and traceability were not achieved by the authors. In addition, the regime is vulnerable to smart card attacks by privileged insiders and proposed a smart home authentication system using ECC. For authentication purposes the authors do not need to store the test table.

The writers have however not performed satisfactorily. XACML has been developed to provide standardize descriptions of the access control policies, based on the eXtensible Markup Language (XML). OAuth is a tool for providing web services and applications with a system of access control that is used in this model. It is currently the most widely used application of this kind, which has led to considerable efforts to provide IoT-based OAuth solutions. Dahshanet suggests a distributed IoT key management system in which Secret sharing is used by the Protocol. The cloud certificate authority and the relevant certification authority (CA) Public Key will be shared by each entity during offline development. After network implementation, companies can run a distributed protocol to create a private/public session key for each network entity. These keys are used to ensure communication among IoT network entities.

The introduced a new hierarchical WSN authentication management model that supports the dynamic node function of adding a system that is called lightweight as it uses lightweight primitive cryptography. proposed an ECC-based user authentication program that is vulnerable to high calculation and security drawbacks. The user authentication with access control system for IoT is proposed RBAC access control is included in the scheme.

The related art suggests a scheme for authentication based on Elliptic Curve cryptography (ECC) for a public and a private key pair. During the initialization process, the elliptical curve public parameters are initialized and calculated. Next, during authentication, these criteria are used. It is implemented a lightweight shared authentication protocol based on RFID-based XOR encryption. The authors have eliminated complex encryption systems such as a single-way hash function, asymmetric encryption.

The two-factor one-time password (OTP) technique proposed by Shivrajetal is based on an easy ECC system based on identity. Compared with current approaches, this approach was better in performance and safety for two reasons. First, there are no key storage requirements for the Key Distribution Centre (KDC). Secondly, it does not store other devices' private and public keys. A limited number of resources were used in this protocol, which negatively affected security. The two problems with this approach are that a device wants to manage another device in another gateway, and that the device wants to manage the instance in which it wishes to monitor using a different security system. This method has no protection for the instance in which a device wants to manage the other device.

The introduced a range of Slim Extensible Authentication Protocol over LAN (SEAPOL), an improved version of the Extensible Authentication Protocol on LAN, lightweight authentication, and authorization mechanisms (EAPOL). Authentication and permission features have also been integrated with restricted devices through the proposed frameworks. In addition to data graph transport layer protection, EAPOL weights down the restricted strategies by helping them to implement and execute EAPOL. However, not only can these proposed mechanisms optimize interoperability among IoT devices, they also address safety and privacy issues in the IoT environment.

### BRIEF SUMMARY

The objectives of the embodiments described herein are as follows. First, an objective is to provide a secured node authentication and access control model for an IoT smart city using double hashed unique labelled key based validation that is used for enhancing the security models in the wireless networks. Second, another objective is to provide a secured node authentication model that authorizes the nodes involved in the network for communication. Third, another objective is to provide an efficient access control model in that is used to grant or restrict access to the nodes in the IoT for completing the data transmission. Fourth, another objective is to provide a double hashing model to generate a key that is used for the authorization of the nodes in the network. Fifth, another objective is to provide a unique label generation process that is used for node authentication in the sensor networks to improve security levels.

IoT transforms objects from classical to intelligent by manipulating the primary technology, such as computer technology, communication skills, protocols for the Internet and applications. It made things smarter and more available to us by combining them with sensors, and connectors, which lead to better human lives, more comfort, protection, and the efficient use of natural resources. In the past decade, IoT has been quietly and steadily addressing human lives, the developments in wireless communications, embedded systems, and energy-efficient radio technology are the most important steps in enabling smaller devices to respond to their environment and control it and form a new physical object networking paradigm. IoT vision makes it possible to connect all to anyplace and anytime and to develop more applications and services that will change the way of interaction with the health, economics, and social life.

Traditional network solutions do not fit well with the development of IoT applications, so the risk of malicious attacks is increased, and confidentiality becomes vulnerable if any of the devices are compromised. Downloading cameras, breaching confidentiality, and accessing material are some of the security risks to IoT and could lead to dangerous results. The IoT world is becoming complicated and emerging technologies are complicating privacy concerns.

The modem network structure, scene, terminal equipment, and other IoT factors are raising these concerns and cannot solve these problems via conventional IoT firewalls or key chain pairs or authentication protocols. Unlicensed access therefore needs to be adequately assessed. As IoT is still an immature technology, and in particular IoT's protection of access control of miniaturized items has now developed to the forefront in terms of safety and privacy, as access control technologies remain an important element for addressing security and privacy risks in the computer grid.

Although IoT's future prospects are better, the implementation of IoT does create little known safety challenge. In this proposed work, problems relating to access control and authentication are taken into account. The recent creation of IoT results in an increasingly difficult situation in which data protection issues are being maintained, tracked, and managed across the network of items, such as data related to healthcare and personal and official records, for example.

The Information Technology is a new paradigm which concentrates on how objects or devices interconnect with one other and with users. The majority of IoT interactions move from ‘human to stuff’ This technology is expected to become a key milestone in the creation of smart Cities in order to make our lives and cities more comfortable and efficient. By taking this IoT smart City technology, the safety of these systems would have significant consequences. Connecting any intelligent entity inside the house with and without the Internet leads to privacy and security issues, such as confidentiality, validity, and integrity of data.

These technologies are highly vulnerable to various security attacks which make an IoT-based smart City insecure for people to live in, and so safety risks need to be assessed to measure the smart house situation. In order for any technology to succeed and become commonly used, proper security and privacy guarantees must win the confidence of users. As in every industry, protection is a vital task. As smart cities are computerized and supplied with computers, it is essential to examine the possible computer protection and impacts on residents.

### Challenges in IoT Security and Privacy

The challenges due to the specific characteristics of IoT are indicated here.

### Heterogeneous Communication and Devices

The IoT network is an integration between the physical world and the cyber world means it is a diverse range of devices from small sensors to bigger devices like servers. It is heterogeneous since devices are manufactured by different producers with different software and hardware specifications. The IoT network includes various platforms. For example, IP-based security solutions like IPsec, SSL and SSH that cannot be applied directly to restricted devices such as sensors which leave an unsecured class of devices that threaten the overall network, making this heterogeneity difficult to use traditional security mechanisms.

### Physical Equipment Integration

The attacker can interfere even more than before to surrounding gadgets in a smart City where the owner can have remote control access and if an attacker violates the protocol services in safety, and gain the access on the lighting system that can be controlled, the TV channels are deleted and can lock the doors etc. The presence of physical devices in contact raises the risk of violation of safety. A recent study has shown that 32% of the total botnet is triggered by smart appliances such as smart television and monitors using physical devices by the attackers. For example, the lights of a smart house might be jeopardized by an intruder or for the whole city, which would endanger the lives of the people.

Resource Handling Limitations

Manufacturers of IoT devices aim to reduce production costs and improvements, which means that the majority of IoT devices have a limited resource capacity, limited memory space, limited resources, and bandwidth. These strict characteristics have considerably limited the security solutions' potential choices and made conventional safety strategies unenforceable for such a setting. Nevertheless, some IoT units have only minimal battery capacity to perform planned functions and severe security guidelines on cryptographic algorithms that can drain the batteries of the equipment in outdoor or aggressive environments where constant power is not available for charging.

### Wide-Scale

The number of computers connecting to the Internet is now higher than the number of people on the planet. This is already substantially increasing and is predictable to range up to 55 billion by 2022. Moreover, the management of this number of devices is difficult with this large number of intelligent devices inevitably leading to increased safety risks. The node registration process by the Registration Authority (RA) is performed as

{
RM ← N{Ti, NID,RC}
RA ← RM{ Ti, NID,RC}
RA → Ti⊕ Th&& NID ∥ Rid
RM ← RA{UL}
N(ID) ← RM(N(UL))
}

Unique Label UL is calculate as

$$P 1 = Ni ( \begin{matrix}M \\ N\end{matrix} ) ⊕ Ti * Th$$

P2=P1<<M⊕N+NID(i)

P3=N<<P2>>M∥P1⊕P2>>M+N

P4=leftcirshif(P2⊕P3)+M&&N⊕ mod(M,n)⊕rightcirshif(P1⊕P3)

N(UL)←P4⊕P2

Here NS is the Nodes Set, N(ID) is the current node identity, Ti is the time instance, RC is the request code, NID is the node id, Th is the threshold value considered and UL is the unique label generated and allotted. The user authentication process as follows:
Initially User U provide the basic information to the Local Authorization Authority (LAA) via Node Routing Module (NRM)

U→UIDᵢ:Re sᵢ→NRM

Re s→U(L):Re sᵢ,Re sj→NRM

L→R:Mᵢ(ID∥Re qₜ∥Re q_{D}),Re sₙ

NRM↓Nᵢ↓R:Mi(L)

∀(Uᵢ,Re sᵢ)∈Rsₙ,(Mₜ(ID∥Re qₜ∥Re q_{D}),H_{L}(Re sᵢ)),(Mₜ(ID∥Re qₜ∥Re q_{D})≈Mᵢ))LAA(U(ID))↓NRM{U,Re sᵢ,Re sj,Mₜ,Re qt,Re q_{iD},Rs}

Here U is the user, UID is the user ID, Res is the resource need to request, Lis the limit of resources, Resi and Resj are the neighboring resources to request, M is the total resources allotted, Reqt and ReqD are the requests for resource and the neighbor resource. The user will be registered with the local authorization authority as:

LAA(U(i))=Σ_{i∈U,Re s,Re q,L}^{N}U(ID)ⁿ+min(Mi)

The process of Double hash key generation and access control is performed as:
1. LAA chooses a random number Nr and calculates NIDₙ=h(U(ID)ₙ∥Tiₙ). Then NRM sends {UIDₙ, Re sᵢ} to LAA using a private channel.
2. LAA generates unique label UL and computes Initial Hash Key IHK_{N(i)}=h(U(ID)ᵢ∥Re sᵢ∥M₁⊕Th), where Res is the resource, Mis the limit, and Tₕ is the threshold.
3. The MK will be updated using a double hash model that finally generates the Double hash key that is used for the user authorization and grant access to the network. The process of double hashing is done as:

DH_{N(i)}=IHK_{N(i)}⊕h(U(ID)ᵢ∥Tiₙ)∥Re s(U(ID)ₙ∥Mₙ⊕Re q(ID))

After calculating the DH value, the Double Hash Key (DHK) is calculated as:

$$DHK ( UID ( i ) ) = {\sum }_{I = 1} {\sum }_{j = i - 1} {M}_{j}^{l} * {Res}_{i}^{N} + {\sum }_{i , j ∈ N} {DH}_{i , j} ( {Req}_{N} ( i ) )$$

After calculating the double hash key, the user authentication process will be performed and then the access will be granted based on the status of authentication. The access grant is scheduled as:

$$AG ( {U ( iD )}_{n} = \{ \begin{matrix}if ( U ( {ID}_{i} ) ∈ {US}_{i} , N permit access \\ otherwise ( U ( {ID}_{i} ) ∉ {US}_{i} , N deny access\end{matrix}$$

The proposed Double Hashed Unique Labelled Key based Validation model exhibits better performance in providing strong authentication and access control mechanism. The parameters exhibited are User Authentication Time Levels, Unauthorized User Detection Time Levels, Unique Labelled Key Generation Time Levels, Smart City Security Levels during Instruction Transmission, Access Control Restriction Level for Unauthorized Users.

Protection of IoT control is one of the world's leading research areas. The authenticity of the information source must first be checked in order to ensure the reliability of the device control. The proposed model aims to include a suitable IoT control system authentication method with restricted access control. The proposed model suggested an improved system of shared authentication, discussed in depth the mechanism including the steps for enhancement, the authentication, and the access control model. The results of analysis show that the concept is a reasonably viable model of IoT-control security authentication.

The proposed model demonstrates a methodology and presents an application for user authentication model using double hashed unique labelled key and allows access control for authorized users only. The main focus of this mode is user authentication with restricted access control. The proposed model generates a unique labelled key that is generated using double hashing. The generated key is used among the IoT devices to authenticate with the central node verification mode for gaining access control on the network. The proposed model security levels are high, and the user authentication accuracy levels are better than the traditional models.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a diagram illustrating an example IoT application;

FIG. 2 is a diagram illustrating an example IoT application;

FIG. 3 is a diagram illustrating example IoT network linked devices;

FIG. 4 is a diagram illustrating smart city controlling models;

FIG. 5 is a diagram illustrating smart city controlling models;

FIG. 6 is a diagram illustrating a proposed model framework;

FIG. 7 is a diagram illustrating a proposed model framework; and

FIG. 8 is a diagram illustrating a proposed model framework.

### DETAILED DESCRIPTION

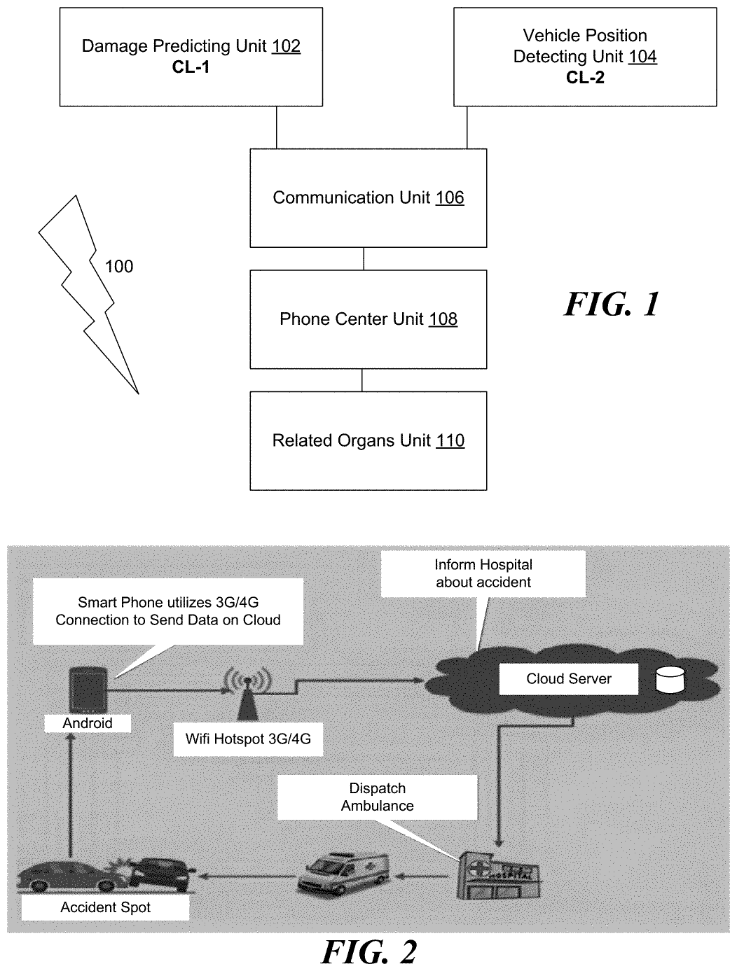

IoT incorporates many current technologies, including Wireless Sensor Networks (WSN), since the 1980s. It is an integral IoT component, since it consists of a set of sensing nodes that are wirelessly linked to each other and afford real-world digital interfaces. However, while IoT infrastructure needs to be secured as a matter of urgency, the above resources limitations of underlying platforms and instruments confront such a need. The identity of the devices and techniques to verify is one of the main aspects of securing an IoT infrastructure. Many IoT devices actually have very poor passwords and many are still using the default passwords provided by the manufacturer, which makes them prone to botnet attacks thereby allowing hackers to hack the IoT networking kits. At the same time, hackers can use false or multifaceted identities to link malicious devices to IoT networks without being detected. Various uses of IoT in several areas are depicted in FIGS. 1 and 2.

As control devices and resource-restricted devices cannot sufficiently compute and store existing mechanisms, which require overall complex calculations, presents an enormous challenge in deploying robust authentication mechanisms. In this proposed model, a Double Hashed Unique Labelled Key based Validation is proposed for an IoT smart City environment. The IoT node routing module redirects the instructions as per the user and node requests, and the local authorization authority will authenticate the users and grant access to them based on their validity.

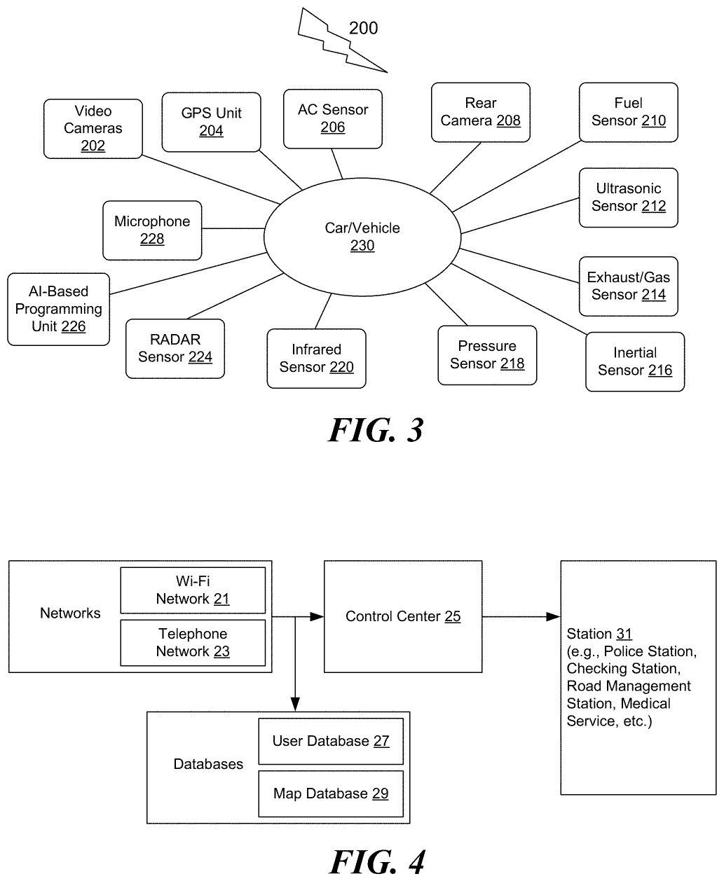

The IoT nodes can be accessed only by the authorized nodes. Nodes can authenticate anonymously and log in to the local authorization authority with unlike dynamic identities and symmetric keys. The security policy implementation between nodes is further guaranteed by the proposed access control mechanism by the configuration of limitation of nodes to send and receive instructions and controls to or from other nodes. The IoT network can be established by connecting to various devices that are indicated in FIG. 3.

A Smart City (SC) is fitted essentially with sophisticated automated systems for different pre-programed operations, such as controlling temperature, lighting, multimedia, operations of the windows, doors, etc. The intelligent home environment is also known as environmental intelligence, which is responsive and adaptive to modern social and human needs. SC has various advantages, such as increasing comfort, improved safety and protection, and more efficient use of energy and other resources, thereby leading to considerable savings.

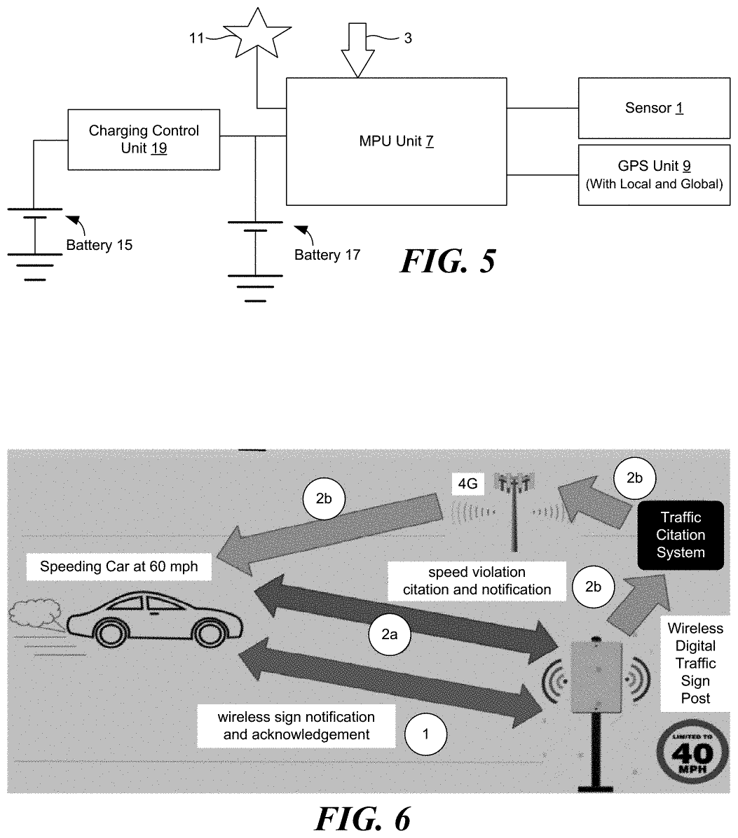

This proposed model will expand over time as it provides strong ways to serve special needs of seniors and disabled people, for environmental monitoring and for regulation. This research application field is extremely important. The main aims of a smart cities are to improve domestic automation, facilitate control of electricity, and reduce environmental emissions. Smart city environments are key in terms of energy usage and comfort for the inhabitants. FIGS. 4-6 are diagrams illustrating the smart city controlling models.

Bringing IoT technology to a Smart City will lead to new security problems and, as IoT based intelligent Cities contain significant and private information, and as they need a high degree of safety. Modern technologies provide both benefits and threats. A Smart City-based IoT is highly vulnerable to internet attacks if an attacker has compromised a smart computer, which can inhibit consumer privacy, and steal and track personal information inside the city, thus taking appropriate action.

The Smart City has security and confidentiality problems as sensitive data collected by intelligent devices are interchanged through wireless networks. If an opponent obtains the data, the opponent abuses it for his own ends. Security and privacy are also key requirements to safe services. The data shared should furthermore follow the requirements of confidentiality, completeness, and availability. Safe and easy authentication protocols are therefore required in IoT-based smart cities to ensure security and privacy. The proposed model has to implement a strong authentication mechanism and allows only authorized users to gain the access control on the system. The proposed model uses cryptography based hashing technique for improving the security levels of the IoT network.

### Proposed Model

IoT is a system in which computers are networked through Unique Identifiers by using Node Identities (NID) as a unique recognition model and can transmit data without any contact between humans. In 1975, the first city automation technology is introduced using X10 a network technology. Electrical cables are used to signal and monitor different electronic devices. In order to monitor a digital electronic system installed in a building, radio frequency signals were used as a digital information.

User authentication is established on the last accessed applications classification scoring before and continuously with an access request for city appliances. This model categorizes the unwanted access for each event obtained from the user's computer and enhances the classifier output by tuning the parameters during the training stage. User Access Request (UAR) is taken on the basis of the last node accessed. The next request will be approved if the last event accessed is classified to the current user and completed without any loss. An authentication procedure will decline the user's access or user demands when the registration authority identifies a duplicate entity or wring information and report it to the local authorization authority and then update a new event model for attaining access to the network.

The authenticity of the information source must first be checked by the registration authority in order to ensure the reliability of the device control. While some authentication frameworks were already proposed by academic fields, there are not fully compliant with IoT environment authentication models. The control system terminal devices generally have increased processing and storage power, which offers new factors for authentication mechanisms of the IoT control system. The features of terminals need to be combined in the control system, balance resources, performance and protection need to be assessed and considered and an authentication method that best suits the IoT control system must be introduced.

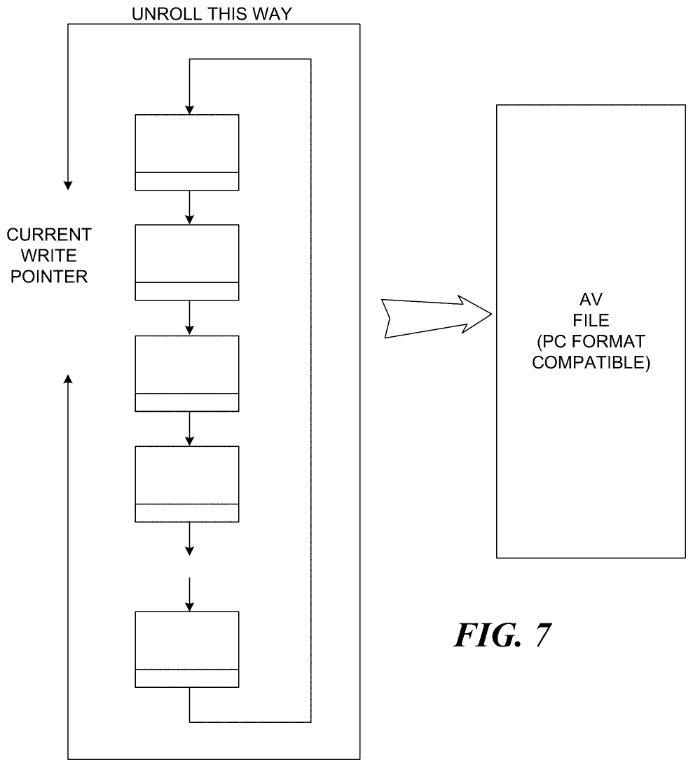

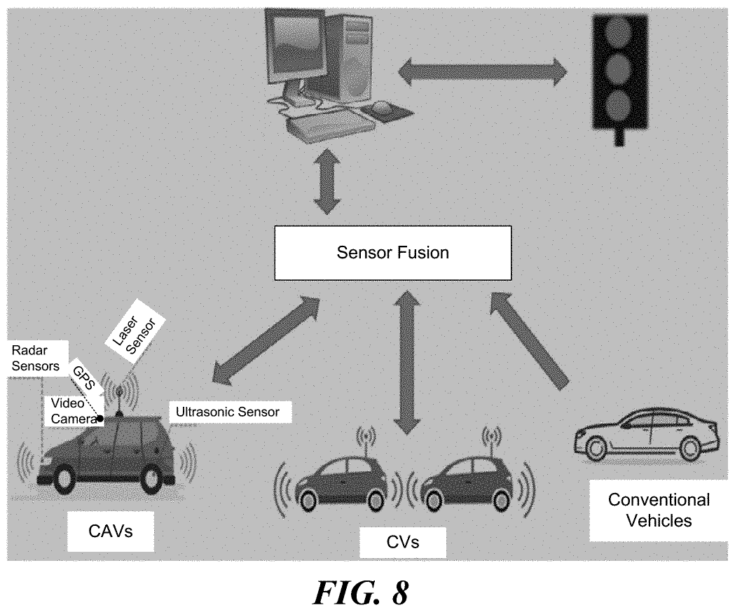

A specific unique label is allotted to the registered users by the registered authority and the data is updated to the local authorization authority to grant access to the networks. The mechanism for User Access Control (UAC) specifying admission to certain resources or facilities provides safety, security, and privacy for IoT devices. UAC is the process that determines who is allowed to have what communications rights that object in respect of certain security models and policies as a fundamental mechanism for ensuring security in computer systems that is completely monitored by the local authorization authority. An efficient UAC system is designed in this model to meet the most important safety criteria, such as privacy, honesty, and availability. The proposed model framework is depicted in FIG. 7.

Here, Ti is the Time Instance, NID is the Node Identity, and RC is the Request Code. The IoT nodes will register with the registration authority by providing the details. The Users wo want to access the devices has to initially gets authenticated by the local authorization authority of the IoT network. The authenticated users only will get access rights so that they can access the required IoT nodes to complete the operation. The double hash key generator will generate and distribute keys using double hashing technique and these keys are used for the user authentication process and granting access rights to them.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1) A Secured Node Authentication and Access Control Model System for IoT Smart City using Double Hashed Unique Labelled Key based Validation, said system comprising:
a. an IoT based global network of linked objects or items that will play an active part in the Future Internet (FI);
b. a heterogeneous nature of IoT communications and with the imbalance in resources between IoT devices, wherein said IoT devices render the provision of the necessary protected connections end-to-end, and wherein said model uses Double Hashed Unique Labelled Key based Validation used for enhancing the security models in the wireless networks.

2) The system as claimed in claim 1, wherein said secured node authentication model system authorizes the nodes involved in the network for communication.

3) The system as claimed in claim 1, wherein said secured node authentication model system is configured to grant or restrict access to the nodes in the IoT for completing the data transmission.

4) The system as claimed in claim 1, wherein said secured node authentication model system generates a key that is used for the authorization of the nodes in the network.

5) The system as claimed in claim 1, wherein said secured node authentication model system involves a unique label generation process that is used for node authentication in the sensor networks to improve security levels.
